(19) United States
(12) Patent Application Publication
(10) Pub. No.: US 2010/0196553 A1
(43) Pub. Date: Aug. 5, 2010

(54) COATING COMPOSITION FOR BAKERY FOOD PRODUCTS AND BAKERY FOOD PRODUCTS USING THE SAME

(75) Inventor: Susumu SATOH, Itami-shi (JP)

Correspondence Address: SUGHRUE MION, PLLC, 2100 PENNSYLVANIA AVENUE, N.W., SUITE 800, WASHINGTON, DC, 20037, US

(73) Assignee: Matsutani Chemical Industry Co., Ltd., Itami-shi (JP)

(21) Appl. No.: 12/697,720

(22) Filed: Feb. 1, 2010

(30) Foreign Application Priority Data
Feb. 5, 2009 (JP) 2009-024730

(51) Int. Cl. A23G 3/54; A23G 3/36

(52) U.S. Cl. 426/94; 426/578

(57) ABSTRACT

The purpose of the present invention is to provide a coating composition for bakery food products, which coating composition is capable of offering a variety of flavors, has superior moisture-retaining property, the coating composition being pleasantly mild, smooth and flexible and in the form of gel; as well as a bakery food product coated with the coating composition. The above problem is solved by the coating composition for bakery food products of the present invention, said coating composition comprising agar, a saccharide, a modified starch and water, which coating composition is in the form of gel.

### TECHNICAL FIELD

The present invention relates to a coating composition for bakery food products and bakery food products using the same.

### BACKGROUND ART

As the finish of bakery food products such as doughnuts and breads, a method for coating their surface with a high concentration of a sugar aqueous solution or the like has been known. This method not only increases an apparent commercial value by giving a shiny look to doughnuts, breads or the like, but also has effects such as flavoring and prevention from drying. Materials used in this method are collectively referred to as “icing”. There are a wide variety of types including glaze (glass) which is frequently used for doughnuts. For instance, a topping composition containing as main ingredients fats and oils, sugars pulverized to an average particle size of 50 μm to 300 μm, and powdered milk pulverized to an average particle size of less than 50 μm has been known (Japanese patent laid-open publication No. 2002-084974). Since all of these contain the sugars as the main raw material, they are, when dried, likely to crack into pieces or peel off, which significantly lowers the commercial value and requires care during the distribution.

A method for coating the surface of confectioneries or breads with fats and oils compositions has also been disclosed. For instance, Japanese patent laid-open publication No. 2008-245577 discloses a method for producing confectioneries or breads, wherein fats and oils compositions are coated without a tempering treatment, the fats and oils compositions containing transesterified fats and oils (not less than 40% by mass) which are made from lauric fats and oils as raw materials and an SUS type triglyceride (20 to 50% by mass) in the fats and oils as well as sugars. The fats and oils compositions are essentially chocolates. Products coated by this method are likely to stick to hands and also readily stick to the surroundings as the fats and oils melt away in the summer months when room temperature is not lower than 30° C. In contrast, in the winter time when temperature is not higher than 15° C., the coated products poorly melt in the mouth and the intrinsic flavors would be lost. Additionally, since the taste of chocolate is very strong, it is difficult to bring out the natural taste of the bakery food products and to make up a variation of tastes by combining with other ingredients, which are problematic.

In addition, Japanese patent laid-open publication No. 2006-271291 discloses a topping composition for bakery food products characterized by containing κ-carrageenan (0.4 to 1.2% by mass) and water-soluble solid contents. This composition requires cations such as calcium ions for gelatinization. Yet, when completely gelatinized, the composition is likely to peel off and requires maintenance of a sol state and control of viscosity so as not to readily flow out. As a result, problems arise in stickiness and change in shape caused by vibration during distribution.

### SUMMARY OF THE INVENTION

### Problems to be Solved by the Invention

An object of the present invention is to provide a coating composition for bakery food products and bakery food products.

More specifically, an object of the present invention is to provide a coating composition for bakery food products, which can solve problems on conventional coating compositions for bakery food products, offers a variety of flavors, has a superior moisture-retaining property, is pleasantly mild and forms a smooth and flexible gel; as well as bakery food products coated with the coating composition, which have a novel texture and shape.

### Means for Solving the Problems

In order to solve the above-mentioned problems, the present inventors intensively studied to discover that a composition mainly containing agar, modified starch and saccharides was suitable as a coating composition for bakery food products, in particular, breads and doughnuts. Additionally, they also found that the bakery food products coated with this composition can be refrigerated, and in particular, doughnuts, when served cool, have a novel texture with refreshing feeling in the summer months. The present invention was made based on such a discovery. Accordingly, the present invention provides the following coating composition for bakery food products as well as bakery food products.
1. A coating composition for a bakery food product, the coating composition comprising agar, a saccharide(s), a modified starch and water, wherein said coating composition is in the form of gel.
2. The coating composition for a bakery food product according to the above-mentioned 1, wherein the modified starch is selected from the group consisting of bleached starch, acetylated distarch adipate, acetylated distarch phosphate, hydroxypropyl distarch phosphate, distarch phosphate and a combination of two or more of them.
3. The coating composition for a bakery food product according to the above-mentioned 1 or 2, wherein the bakery food product is a bread or a confectionery.
4. A bakery food product coated with the coating composition for a bakery food product according to any one of the above-mentioned 1 to 3.
5. The bakery food product according to the above-mentioned 4, the bakery food product being a bread or a confectionery.

### Effects of the Invention

The coating composition according to the present invention can offer a variety of flavors, has superior moisture-retaining property, is pleasantly mild and exhibits a smooth and flexible form of gel. The coating composition according to the present invention can easily add a variety of novel textures to bakery food products and thus can provide novel bakery food products with a sense of the season. The bakery food products including breads and confectioneries which are coated with the coating composition according to the present invention deteriorate less over time. The coating composition according to the present invention is stable against changes in viscosity and retrogradation, and excellent in resistance to retorting, refrigeration and freezing.

### BEST MODE FOR CARRYING OUT THE INVENTION

The term “coating composition” in the present invention means, by coating the surface of bakery food products such as breads after baking and doughnuts after deep frying, a coating composition (also referred to as a topping composition) for giving a variety of textures while maintaining the moisture-retaining property.

The term “modified starch” in the present invention means starch treated physically, chemically, or enzymatically. It is preferred that the modified starch used in the present invention enhances ease of handling by widening a range of suitable temperature at which the surface of the food products is coated with the coating composition, prevents the coating composition from peeling off or flowing (dripping) off from the food products, offers refreshing feeling such as gloss of the coated surface and moistness, and has effects of giving resistance to refrigeration and freezing. In addition, it is preferred that the modified starch does not deteriorate the original texture that the food product has. Preferred examples of the modified starch used in the present invention include bleached starch, acetylated distarch adipate, acetylated distarch phosphate, hydroxypropyl distarch phosphate, distarch phosphate and a combination of two or more of them.

The bleached starch is a starch bleached by adding sodium hypochlorite to alkali starch suspension and does not fall under oxidized starches defined by Ministry of Health, Labour and Welfare ministerial ordinance No. 151 and announcement No. 485 of Oct. 1, 2008. In the present invention, a commercially available bleached starch can be used.

The degree of substitution (a ratio of the total number of moles of the hydroxyl groups in the non-substituted cross-linked starch to the total number of moles of the hydroxyl groups in the substituted cross-linked starch) in acetylated distarch adipate, acetylated distarch phosphate and hydroxypropyl distarch phosphate is preferably 0.01 to 0.2. In cases where the degree of substitution is less than 0.01, turbidity of the coating composition after coating, decrease in gloss, separation of water and the like occur, and the stability tends to decrease. In cases where the degree of substitution is more than 0.2, it tends to have a poor texture due to the stickiness.

In addition, cross-linkings in acetylated distarch adipate, acetylated distarch phosphate, hydroxypropyl distarch phosphate and distarch phosphate stabilize the viscosity and transparency of the coating composition and enhance resistance to retorting, resistance to freezing and resistance to refrigeration as the coating composition. The degree of cross-linking is set forth in terms of the phosphorus content or adipic acid content in Ministry of Health, Labour and Welfare ministerial ordinance No. 151 and announcement No. 485 of Oct. 1, 2008. Therein, the phosphorus content and adipic acid content of the cross-linked starch used in the present invention are preferably not more than 0.04% each (the phosphorus content derived from potato starch is not more than 0.12%). When it is more than 0.04% (0.12% in the case of the phosphorus content derived from potato starch), there is a tendency of the viscosity to decrease. In cases where substitutions and cross-linkings are included, the viscosity and stability against retrogradation of the coating composition are further enhanced.

Examples of raw material starch used for producing these modified starches include wheat starch, corn starch, waxy corn starch, potato starch, waxy potato starch, tapioca starch, rice starch, waxy rice starch, sweet potato starch, sago palm starch and kudzu starch. For enhanced transparency of the coating composition, tapioca starch, potato starch or waxy corn starch are preferred.

The amount of modified starch to be used is preferably 0.2 to 5.0% by mass, more preferably 0.3 to 3.0% by mass, based on the entire coating composition. It is not preferred to be less than 0.2% by mass from the viewpoint of prevention of dripping, water separation, or dryness. Also, when it is more than 5.0% by mass, the viscosity increases and the surface tends to be uneven.

The saccharide(s) used in the present invention is (are) water-soluble saccharides functioning to retain water in bakery food products, in addition to a function as a sweetener. Examples thereof include sucrose, lactose, fructose, oligosaccharides, invert sugar, grape sugar, powdered sugar, malt sugar, sugar alcohols, dextrin and starch syrup. Also, when accessory ingredients such as powdered fruits, powdered fruit juice, bean paste, jams, honeydew nuts (e.g. chestnut) or kanrokei nuts, sugared beans or amanatto, or fruits are included in the coating composition according to the present invention, water-soluble solids contained in those are used as part of the saccharides used in the present invention. These saccharides may be used individually or in combination. These saccharides are blended such that the sugar content (water-soluble solid content) in the coating composition is preferably 40 to 70, more preferably 52 to 65. When the sugar content is less than 40, moisture is likely to migrate to the dough and the taste tends to deteriorate. Also, when the sugar content exceeds 70, moisture in the dough is likely to decrease and the whole food product tends to be easily dried. The term “sugar content” in this description means the concentration of water-soluble solid content and value thereof measured at 20° C. by a Brix meter.

As the agar used in the present invention, commercially available one can be used. And, commercially available powdered agar can be used. The amount of agar to be used is not restricted as long as the coating composition is, when heated, readily dissolved so that coating is easy; and, when cooled, is in a flexible form of gel. However, in view of the texture and coating stability, the amount is preferably 0.2 to 2.0% by mass based on the amount of whole coating composition.

Examples of the bakery food product in the present invention include deep fried confectioneries such as cake doughnuts, yeast doughnuts, French crullers, deep fried sugar-coated doughs or karintou, or deep fried rice crackers or age senbei; baked confectioneries such as cookies, cakes, scones, muffins, baumkuchens, crackers or choux; and breads such as loaf bread, butter rolls, Danish pastries or croissants.

Additionally, examples of the confectioneries include steamed or baked buns filled typically with sweetened bean paste or manjyuu, sponge cakes or kasutera, sweetened bean paste sandwiched with pancakes or dorayaki, round pancakes stuffed typically with sweetened bean paste or imagawayaki, fish-shaped pancakes stuffed typically with sweetened bean paste or taiyaki, sword guard-shaped cakes with sweetened bean paste being wrapped with crepe or kintsuba, waffles, baked buns with chestnut or kurimanjyuu, moon cakes or geppei, small round cookies or boro, cinnamon-flavored crepe made from rice flour or yatsuhashi, sponge cakes, roll cakes, steamed cakes, angel cakes, pound cakes, fruit cakes, madeleines, cream puffs, eclairs, mille-feuilles, apple pies, tarts, steamed bread, pretzels, wafers, snack foods, pizzas, crepes, souffles and beignets. Examples of the breads include spindle-shaped rolls or koppe pan, fruit bread, corn bread, hamburger buns, rolls, sweetened pastries, sweet doughs, bagels, croissants, Danish pastries and nans.

The coating composition according to the present invention can contain agar, saccharides and modified starch as main ingredients and, other than those, accessory ingredients as needed. Examples of the accessory ingredients include cocoa raw materials such as cacao mass, cocoa cakes or cocoa powders; powdered dairy products such as whole milk powder, powdered skim milk, powdered (fresh) cream, powdered cheese, powdered yogurt; various powders such as powdered fruits, powdered fruit juice, coffee powders, tea powders, green tea powders, curry powders, seasoning materials, sweetened bean paste, jams, honeydew nuts (e.g. chestnut) or kanrokei nuts, sugared beans or amanatto, fruits and flavoring agents.

Also, agar used for the coating composition according to the present invention can be used in combination with other gelling agents such as carrageenans, pectins or gelatins.

The coating composition for bakery food products according to the present invention can be produced by simultaneously or separately dissolving agar, modified starch, saccharides and, as needed, accessory ingredients into water under heat, or simultaneously or separately mixing them as they are. For instance, it can be made by the following method.

1. Water is added to powdered agar, and the mixture is dissolved under heat at, for example, 85 to 100° C.

2. Saccharides are added and dissolved.

3. Modified starch dissolved in water is added and the mixture is heated to an intended final sugar content.

4. Additional accessory ingredients are, as needed, added and mixed.

5. The resultant is used as is as the coating composition while maintained at not lower than 50° C. and lower than 100° C.

The obtained coating composition can be refrigerated or frozen as is for storage. Or it can be filled in a pouch bag followed by retort sterilization; stored at room temperature or low temperatures; and, when used, reheated for use as a coating composition.

The food coating composition for bakery food products according to the present invention filled in the pouch bag can be, after heated, used as is. Thus, it is not necessary to conduct a preparation process for each use.

In addition, a powdered mixture of agar, modified starch and saccharides can be prepared as a base coating composition and, when used, mixed and dissolved with accessory ingredients as required, thereby obtaining the coating composition.

The thus prepared coating composition is used in coating bakery food products while kept preferably at not lower than 50° C. and lower than 100° C., usually at about 60° C.

The thickness of coating can be adjusted by adjusting a coating temperature. At a temperature of lower than 50° C., the viscosity increases, resulting in poor ease of handling. As a method for coating, for instance, applying the coating composition using a glazer, immersion using an immersion machine, dipping bakery food products in a container filled with the coating composition, or coating using a brush or the like. The coating may be applied to a portion of the surface of the bakery food product or may be applied to the entire surface thereof.

After the coating composition according to the present invention was coated on the surface of the bakery food product in the above-described manner, when cooled or left to stand naturally, the coating composition is gelatinized as temperature decreases. As a result, the bakery food product has a glossy surface and refreshing feeling with moist feeling and juicy-fresh appearance. In addition, the coating is stable and does not peel off or flow off from the food product. Further, since water is not separated from the coating composition, it is advantageous in that it is not sticky and thus has good ease of handling.

The bakery food products coated with the coating composition according to the present invention can be refrigerated or frozen for storage, and the quality of the product prior to freezing can be restored when thawed naturally.

### Examples

The present invention will now be described more concretely by way of examples thereof.

### Example 1

### Preparation of the Base Coating Composition for Bakery Food Products

Hydroxypropyl distarch phosphate (1.5 g) derived from waxy corn starch (degree of substitution: 0.14, phosphorus content: 0.004%, manufactured by Matsutani Chemical Industry Co., Ltd.), powdered agar (1.0 g) (manufactured by Ina Food Industry Co., Ltd., ZR) and water (60 g) were mixed and the mixture was dissolved under heat at about 95° C.

Subsequently, granulated sugar (65 g) and low sweet reduced starch syrup (50 g) (Matsutani Chemical) were added and dissolved, and the resultant was heated to a final sugar content of 60, thereby obtaining a coating composition. This coating composition, when allowed to cool to lower than 50° C., was in the form of gel as fluid sols were condensed and solidified into jellies. After being allowed to cool to room temperature, this was stored in a refrigerator (5° C.) until it is used.

### Comparative Example 1

A coating composition was prepared in the same manner as described in Example 1 except that an equal amount of potato starch was used in place of modified starch (hydroxypropyl distarch phosphate derived from waxy corn starch).

### Comparative Example 2

Although the same procedures as described in Example 1 except that the agar was not used were carried out, gels were not formed. Thus, the obtained product was not able to be used as a coating composition.

### Comparative Example 3

Although the same procedures as described in Example 1 except that κ-carrageenan was used instead of the agar were carried out, the obtained product retained a sol state and the coating composition in the form of gel according to the present invention was not obtained.

### Example 2

### Preparation of a Soft Sweetened Bean Jelly (or Mizuyoukan) Type Coating Composition for Bakery Food Products

Powdered agar (6 g) was suspended in water (350 g) and the mixture was dissolved under heat at about 95° C. Next, granulated sugar (360 g), powdered dried unsweetened azuki bean paste (or azuki sarashi namaan) (220 g) and low sweet reduced starch syrup (70 g) were successively fed and dissolved. Further, hydroxypropyl distarch phosphate (6 g) derived from tapioca (degree of substitution: 0.078, phosphorus content: 0.005%, manufactured by Matsutani Chemical Industry Co., Ltd.), which was dissolved in water, and table salt (0.3 g) were added and heated to a final sugar content of 62, thereby obtaining a coating composition. This coating composition, when allowed to cool to lower than 50° C., is in the form of gel as fluid sols were condensed and solidified into jellies. After being allowed to cool to room temperature, this was stored in a refrigerator (5° C.) until use.

### Example 3

### Preparation of a Powdered Green Tea Flavored Soft Sweetened Bean Jelly (or Mizuyoukan) Type Coating Composition for Bakery Food Products

Powdered agar (8 g) was suspended in water (350 g) and the mixture was dissolved under heat at about 95° C. Next, granulated sugar (250 g), white bean paste (or shironamian) (400 g) and low sweet reduced starch syrup (70 g) were successively fed and dissolved. Further, hydroxypropyl distarch phosphate (8 g) derived from tapioca (degree of substitution: 0.066, phosphorus content: 0.005%, manufactured by Matsutani Chemical Industry Co., Ltd.), which was dissolved in water was added and heated to a final sugar content of 64. The resultant was allowed to cool briefly and then powdered green tea (25 g) suspended in water (50 g) was added thereto, thereby obtaining a coating composition. This coating composition, when allowed to cool to lower than 50° C., is in the form of gel as fluid sols were condensed and solidified into jellies. After being allowed to cool to room temperature, this was stored in a refrigerator (5° C.) until use.

### Example 4

### Preparation of a Strawberry Flavored Coating Composition for Bakery Food Products

Powdered agar (6 g) and water (150 g) was mixed and dissolved under heat at about 95° C. Next, granulated sugar (150 g) and low sweet reduced starch syrup (100 g) were successively fed and dissolved. Further, hydroxypropyl distarch phosphate (12 g) derived from waxy corn starch (degree of substitution: 0.078, phosphorus content: 0.005%, manufactured by Matsutani Chemical Industry Co., Ltd.), which was dissolved in water was added and dissolved under heat at about 95° C. Finally, strawberry jam (sugar content 55) 100 g was added, stirred and heated to a final sugar content of 57, thereby obtaining a coating composition. This coating composition, when allowed to cool to lower than 50° C., is in the form of gel as fluid sols were condensed and solidified into jellies. After being allowed to cool to room temperature, this was stored in a refrigerator (5° C.) until use.

### Example 5

### Preparation of a Mango Flavored Coating Composition for Bakery Food Products

Powdered agar (4 g) and water (70 g) were mixed and dissolved under heat at about 95° C. Next, granulated sugar (100 g), low sweet reduced starch syrup (100 g) and sodium citrate (2 g) were successively fed and dissolved. Further, acetylated distarch phosphate (5 g) derived from tapioca starch (degree of substitution: 0.042, phosphorus content: 0.007%, manufactured by Matsutani Chemical Industry Co., Ltd.), which was dissolved in water was added and dissolved under heat. Finally, mango puree (100 g) was added, stirred and heated to a final sugar content of 53, thereby obtaining a coating composition. This coating composition, when allowed to cool to lower than 50° C., is in the form of gel as fluid sols were condensed and solidified into jellies. After being allowed to cool to room temperature, this was stored in a refrigerator (5° C.) until use.

### Example 6

### Preparation of a Roasted Sweet Potato Flavored Coating Composition For Bakery Food Products

Water (150 g) and powdered agar (7 g) were mixed and dissolved under heat at about 95° C. Next, granulated sugar (200 g) and low sweet reduced starch syrup (80 g) were successively fed and dissolved. Further, distarch phosphate (15 g) derived from waxy rice starch (phosphorus content: 0.023%, manufactured by Matsutani Chemical Industry Co., Ltd.), which was dissolved in water was added and dissolved under heat. Finally, pureed roasted sweet potato (250 g) was added, stirred and heated to a final sugar content of 52, thereby obtaining a coating composition. This coating composition, when allowed to cool to lower than 50° C., is in the form of gel as fluid sols were condensed and solidified into jellies. After being allowed to cool to room temperature, this was stored in a refrigerator (5° C.) until use.

### Example 7

### Preparation of a Custard Pudding Flavored Coating Composition for Bakery Food Products

Cow milk (65 g), egg yolk (10 g) and low sweet dextrin (25 g) (Matsutani Chemical Industry Co., Ltd.) were mixed. To this mixture, granulated sugar (50 g), powdered agar (3 g) and hydroxypropyl distarch phosphate (3 g) derived from corn starch (degree of substitution: 0.098, phosphorus content: 0.008%, manufactured by Matsutani Chemical Industry Co., Ltd.) were fed and dissolved under heat at about 50° C. Further, the mixture was stirred using a T. K. homomixer at 5,000 rpm for 5 minutes, further stirred while heated in a bath filled with boiling water and adjusted to a final sugar content of 59, thereby obtaining a coating composition. This coating composition, when allowed to cool to lower than 50° C., is in the form of gel as fluid sols were condensed and solidified into jellies. After being allowed to cool to room temperature, this was stored in a refrigerator (5° C.) until use.

### Example 8

### Preparation of a Mix Powder Used in the Soft Sweetened Bean Jelly (or Mizuyoukan) Type Coating Composition for Bakery Food Products

Powdered dried azuki bean paste (or azuki sarashiko) (100 g), powdered low sweet reduced starch syrup (manufactured by Matsutani Chemical Industry Co., Ltd.), hydroxypropyl distarch phosphate (6 g) derived from tapioca and powdered agar (5 g) were uniformly mixed to prepare a mix powder used in the soft sweetened bean jelly (or mizuyoukan) type coating composition for bakery food products.

To this mix powder (100 g), granulated sugar (400 g) and water (500 g) were added, dissolved under heat at about 95° C., and then further heated to boil. Thereafter, the resulting mixture was allowed to cool to about 60° C. and used as a coating composition.

### Example 9

### Preparation of Doughnuts Coated with the Coating Composition and Evaluation Thereof

The raw materials in the formulation shown in Table 1 were mixed with a bread mixer at low speed for 1 minute and at mid to high speed for 1 minute, thereby obtaining uniform dough. This dough was rolled out to a thickness of 1 cm, cut into pieces of 45 g each using a ring-shaped cutter. The cut dough was put in oil at 180° C. and deep-fried for 1 minute per side, that is, a total of 2 minutes, thereby preparing cake doughnuts.

TABLE 1

| | Blend formulation |
|---|---|
| Raw materials | (parts by mass) |
| Hard wheat flour | 20 |
| Soft wheat flour | 80 |
| Granulated sugar | 40 |
| Powdered skim milk | 10 |
| Baking powder | 5 |
| Table salt | 1 |
| Shortening | 8 |
| Vanilla flavoring | 0.1 |
| Whole egg | 20 |
| Water | 40 |

The thus prepared cake doughnuts were coasted with the coating composition prepared Examples 1 to 7 or Comparative Example 1. That is, the coating compositions refrigerated were dissolved under heat using a microwave oven and kept at about 60° C. One side of the cake doughnut was dipped and then left to stand at room temperature for 30 minutes, thereby obtaining the cake doughnut coated with 13 g of the coating composition.

For these doughnuts, the outer appearance and texture were examined by sensory evaluation by ten panelists with ratings on a 5-point scale. The sensory evaluation items and criteria are shown in Table 2.

TABLE 2

| Items | Points | Evaluation criteria |
|---|---|---|
| Outer | 5 | The surface is very glossy, uniformly coated and |
| appearance | | is not sticky. |
| | 4 | The surface is glossy, uniformly coated and is not |
| | | sticky. |
| | 3 | The surface is somewhat glossy, uniformly coated |
| | | and slightly sticky. |
| | 2 | The surface is not somewhat glossy and, in part, |
| | | unevenly coated. Bothersome stickiness is |
| | | noticed. |
| | 1 | The surface has no gloss. The coating |
| | | composition is solidified. So sticky that hands |
| | | are smudged. |
| Textures | 5 | Smooth and excellent mouth melting |
| | 4 | Smooth and good mouth melting |
| | 3 | Somewhat lack of smoothness but good mouth |
| | | melting |
| | 2 | Sticky feeling and bad mouth melting |
| | 1 | Strong sticky feeling. Lumpy and lingering in the |
| | | mouth. |

The obtained results (average values) are shown in Table 3. The total evaluation (Total) in Table 3 means the average of the evaluated values for the outer appearance and the textures

TABLE 3

| | Comparative | Examples | | | | | | |
|---|---|---|---|---|---|---|---|---|
| Items | Example | 1 | 2 | 3 | 4 | 5 | 6 | 7 |
| Outer | 1.5 | 4.6 | 4.5 | 4.5 | 4.4 | 4.1 | 4.2 | 4.3 |
| appearance | | | | | | | | |
| Textures | 1.7 | 4.2 | 4.5 | 4.3 | 4.0 | 3.9 | 4.0 | 4.3 |
| Total | 1.6 | 4.4 | 4.5 | 4.4 | 4.2 | 4.0 | 4.1 | 4.3 |

From this result, it was found that the food products coated with the coating composition according to the present invention receive a high evaluation in terms of the outer appearance and textures.

### Example 10

### Preparation of Butter Rolls Coated with the Coating Composition and Evaluation Thereof

The raw materials of the formulation shown in Table 4 except for butter were mixed with a bread mixer at low speed for 2 minutes and at mid speed for 5 minutes. The butter was added and the mixture was further mixed at low speed for 1 minute, at mid speed for 5 minutes and at high speed for 1 minute, thereby obtaining uniform dough. This was fermented for 90 minutes and divided into pieces of 50 g each. After a bench time of 25 minutes, the thus obtained pieces were molded. After a time for final proof of 50 minutes, the resulting dough was baked at 200° C. for 10 minutes, thereby obtaining butter rolls.

TABLE 4

| | Ingredient formulation |
|---|---|
| Raw materials | (parts by mass) |
| Hard wheat flour | 100 |
| Granulated sugar | 10 |
| Powdered skim milk | 4 |
| Table salt | 2.5 |
| Raw yeast | 3 |
| Butter | 10 |
| Whole egg | 10 |
| Water | 50 |

The thus prepared butter roll was coated with 9 g of the coating composition and sensorially evaluated in the same manner as described in Example 9. As a result, as shown in Table 5, the results similar to what was seen in Example 9 were obtained.

TABLE 5

| | Comparative | Examples | | | | | | |
|---|---|---|---|---|---|---|---|---|
| Items | Example | 1 | 2 | 3 | 4 | 5 | 6 | 7 |
| Outer | 2.0 | 4.2 | 4.4 | 4.2 | 4.0 | 4.0 | 4.3 | 4.0 |
| appearance | | | | | | | | |
| Textures | 1.6 | 4.4 | 3.8 | 4.4 | 4.2 | 4.2 | 4.1 | 4.0 |
| Total | 1.8 | 4.3 | 4.1 | 4.3 | 4.1 | 4.1 | 4.2 | 4.0 |

### Example 11

### Preparation of Sponge Cakes Coated with the Coating Composition and Evaluation Thereof

By the formulation shown in Table 6, in accordance with an all-in-mix method, sponge cakes (330 g) were prepared.

TABLE 6

| | Ingredient formulation |
|---|---|
| Raw materials | (parts by mass) |
| White superior soft sugar | 300 |
| Emulsified fat | 37.5 |
| Whole egg | 350 |
| Soft wheat flour | 250 |
| Water | 45 |

The thus prepared sponge cake was coated with 66 g of the coating composition and sensorially evaluated in the same manner as described in Example 9. As a result, as shown in Table 7, the results similar to what was seen in Example 9 were obtained.

TABLE 7

| | Comparative | Examples | | | | | | |
|---|---|---|---|---|---|---|---|---|
| Items | Example | 1 | 2 | 3 | 4 | 5 | 6 | 7 |
| Outer | 1.9 | 4.0 | 4.5 | 4.1 | 3.8 | 4.2 | 4.2 | 4.4 |
| appearance | | | | | | | | |
| Texture | 2.1 | 4.4 | 4.1 | 4.1 | 4.0 | 4.0 | 4.0 | 4.2 |
| Total | 2.0 | 4.2 | 4.3 | 4.1 | 3.9 | 4.1 | 4.1 | 4.3 |

### Example 12

### Preparation and Evaluation of a Soft Sweetened Bean Jelly (or Mizuyoukan) Type Coating Composition for Bakery Food Products Containing Bleached Starch

Powdered agar (7 g) was suspended in water (350 g) and dissolved under heat at about 95° C. Next, granulated sugar (360 g), unsweetened mashed azuki bean paste with pulp (or azuki tsubushi tsubuan) (230 g) and low sweet reduced starch syrup (80 g) were successively fed and dissolved. Further, bleached starch (6 g) derived from tapioca (Matsutani Chemical), which was dissolved in water, and table salt 0.3 g were added and heated at about 95° C. to a final sugar content of 63. This coating composition, when allowed to cool to lower than 50° C., is in the form of gel as fluid sols were condensed and solidified into jellies. After refrigerated (5° C.), this was reheated for use as the coating composition. Similar to what was seen in Example 9, cake doughnuts coated with this coating composition had a moisture-retaining property, no water separation, as well as soft and smooth textures.

### Example 13

### Storage Stability Test of a Coating Composition

After subjected to refrigerated storage, frozen storage, or retort heating storage, the coating composition prepared in Example 1 was coated onto the cake doughnut in the same manner as in Example 9. And then, the outer appearance and texture were evaluated by the evaluation method described in Example 9. As for refrigerated storage and frozen storage, the coating composition was stored in a sealed container in a refrigerator (about 5° C.) and a freezer (about −18° C.), respectively, for 3 days, and thereafter reheated in a microwave oven. This process was repeated 5 times and the resulting coating composition was subjected to evaluation. The coating composition prepared in Example 1 was subjected, in a sealed container, to retort heating at 120° C. for 10 minutes. Thereafter, the coating composition was stored at room temperature for 2 weeks and then evaluated. The results are shown in Table 8.

TABLE 8

Storage method

| Evaluation | Prior to | | | |
|---|---|---|---|---|
| items | storage | Refrigeration | Freezing | Retort |
| Outer | 4.6 | 4.4 | 4.2 | 4.4 |
| appearance | | | | |
| Texture | 4.2 | 4.2 | 4.2 | 4.2 |
| Total | 4.4 | 4.3 | 4.2 | 4.3 |

From the result shown in Table 8, it was found that the coating composition according to the present invention retains its properties as the coating composition even after the refrigerated storage, frozen storage, or retort heating storage and thus has resistance to refrigeration, resistance to freezing and resistance to retorting.

### Example 14

### Storage Stability Test of Cake Doughnuts Coated with the Coating Composition

In accordance with the method of Example 9, doughnuts coated with the coating composition prepared in Example 1 were stored at room temperature, in a refrigerator, or in a freezer for 3 days. Thereafter, the doughnuts were allowed to return to room temperature and evaluated for its outer appearance and textures in accordance with the method of Example 9. The results are shown in Table 9.

TABLE 9

| | Storage method | | | |
|---|---|---|---|---|
| Evaluation | Prior to | Room | | |
| items | storage | temperature | Refrigeration | Freezing |
| Outer | 4.6 | 4.0 | 4.4 | 4.2 |
| appearance | | | | |
| Texture | 4.2 | 3.8 | 4.2 | 4.0 |
| Total | 4.4 | 3.9 | 4.3 | 4.1 |

From the result shown in Table 9, it was found that the cake doughnut coated with the coating composition according to the present invention retains its properties as the food product even when refrigerated to storage or frozen to storage, and thus has resistance to refrigeration and resistance to freezing. Meanwhile, the cake doughnut which was not coated with the coating composition had a reduced water content, decreased moist feeling and poor texture in any storage mode.

What is claimed is:

1. A coating composition for a bakery food product, said coating composition comprising agar, a saccharide, a modified starch and water, wherein said coating composition is in the form of gel.

2. The coating composition for a bakery food product according to claim 1, wherein said modified starch is selected from the group consisting of bleached starch, acetylated distarch adipate, acetylated distarch phosphate, hydroxypropyl distarch phosphate, distarch phosphate and combinations of two or more of them.

3. The coating composition for a bakery food product according to claim 1, wherein said bakery food product is a bread or a confectionery.

4. The coating composition for a bakery food product according to claim 2, wherein said bakery food product is a bread or a confectionery.

5. A bakery food product coated with said coating composition for a bakery food product according to claim 1.

6. The bakery food product according to claim 5, said bakery food product being a bread or a confectionery.
